(19) United States
(12) Patent Application Publication
(10) Pub. No.: US 2005/0070140 A1
(43) Pub. Date: Mar. 31, 2005

(54) Elastic contact element

(75) Inventor: Alexander Gelman, Fellbach (DE)

Correspondence Address: THE FIRM OF KARL F ROSS, 5676 RIVERDALE AVENUE, PO BOX 900, RIVERDALE (BRONX), NY, 10471-0900, US

(73) Assignee: Hirschmann Electronics GmbH & Co. KG

(21) Appl. No.: 10/916,766

(22) Filed: Aug. 11, 2004

(30) Foreign Application Priority Data
Aug. 11, 2003 (DE) 10336843.4
Jan. 17, 2004 (DE) 102004002511.8

(51) Int. Cl. H01R 4/58

(52) U.S. Cl. 439/86

(57) ABSTRACT

A device for making electrical contact between a first contact partner with at least one further contact partner whereby according to the invention an elastically deformable carrier (1) is provided which is electrically nonconducting and has at least partly a layer (2) which is electrically conducting whereby the contact partners are electrically connected through the layer (2).

The invention relates to a device for making an electrical contact between a first contact partner with at least one further contact partner according to the features of the preamble of patent claim 1.

From the DE 196 05 999 A1, the making an electrical contact with a flat antenna conductor structure is know. In this case, beneath a part of the body of the motor vehicle, a signal processing unit, especially an antenna amplifier is mounted by appropriate fastening means. The housing of this unit has a carrier (outrigger arm) on whose end contact means are provided. These contact means are connected by connecting conductors, which are arranged in or on a rigid carrier, with the signal processing unit. Through the contacting means an electrical contact is made to contact surfaces of an antenna conductor structure which is located on the vehicle window. With the carrier it is thus possible on the one hand to connect the antenna conductor structure with the signal processing unit over a certain distance. Because of the location at which this unit must be mounted on the contact surfaces of the antenna structure, however, large tolerance ranges are required to ensure that the contact means of the unit will meet the contact surfaces of the antenna structure. A further drawback of this construction resides in that the entire signal processing unit with the carrier and the contact means arranged on the carrier must be completely replaced when this unit is for example damaged in a crash of the motor vehicle. This connected with high cost since the signal processing unit as a rule is integrated between the body (vehicle roof) and the ceiling of the vehicle and thus is only accessible with difficulty. Furthermore there is the drawback that with rigid carriers, the geometry of the component must always be matched with he respective vehicle type since each type of vehicle has a different characteristic configuration. This matching is associated with high cost since for each carrier for each vehicle type a different tool for producing the carrier must be made available.

Furthermore, contact elements are known which are comprised of an elastically deformable plastic into which electrical particles have been mixed. These can be inserted between a contact surface of a device and a further contact surface. Such contact elements have however the considerable disadvantage that they are very expensive in that the cost-driving factor with these known contact elements is the preparation of handling of the electrically conductive particles and the production of an extrudable mass which contains these conductive particles. This drawback is especially severe when contact elements are required in large numbers for devices which are produced by mass production.

The invention thus has as its object to provide a device for making electrical contact between a first contact partner and at least one further contact partner whereby the drawbacks described at the outset are avoided and whereby the device can be made especially cost effectively, especially as concerns manufacture by mass production.

This object is attained through the device of patent claim 1.

According to the invention an elastically deformable carrier is provided and is comprised of an electrically nonconductive material which has at least partly and in an especially advantageous manner over its entire surface, that electrically conductive layer whereby the contact partners electrically contact each other through this layer.

As a result, elastic contact elements are provided for making electrical contact between two or more contact partners which can be simply and cost-effectively fabricated and in addition, because of their deformability can compensate for tolerances between the at least two contact partners. For the fabrication such elastic contact elements it is significantly simpler and more cost effective to use an electrically nonconductive elastic carrier, for example of an elastomer containing material or formed completely from an elastomer and which is provided in a simple manner and way with an electrically conductive layer. For this purpose, the electrically conductive layer can be applied for example by dispersion, metal spraying, painting, printing (stamping or embossing), by a chemogalvanic [electrodeposition], electrostatic or like techniques by the electrically nonconductive carrier. The elastic contact element made in this manner have the advantage that they can be disposed between the at least two contact partners and on the one hand enable the convenient electrical contacting to be made between them in the electrically conductive layer which is applied and simultaneously ensure, based upon the elastic deformability, a compensation for tolerances in the gap between the two contact partners. Since it is required to make the electrical contact that the contact element be compressed between the at least two contact partners and that this compression force be maintained during the maintenance of the electrical contact, a durable electrical contact is ensured since the electrically conductive layer is pressed continuously by the elastically deformed carrier against the contact partners.

The compression force can also be generated by other elements, for example by a spring or the like. Furthermore, two or more such contact elements can be arranged in the contact direction [between two contact partners]. The arrangement and fastening of such contact elements in the contact direction can be carried out in various ways.

In an alternative application of the invention, the electrically conductive layer can also be formed by a foil which can be applied to the carrier by means of an adhesive, pressing [hot pressing] or the like. Over all there are therefore various possibilities to satisfactorily provide an elastically deformable and electrically nonconductive carrier with an electrically conductive layer on its surface. Furthermore, the contact elements can be matched prior to and especially after application of the conductive layer to the use or application to which they will be put (for example by cutting, by applying fastening elements or the like).

Four embodiments of the device according to the invention for making electrical contact between a first contact partner and at least one further contact partner, without however limiting the invention to them, are described in the following and in connection with the Figures.

The Figures show:

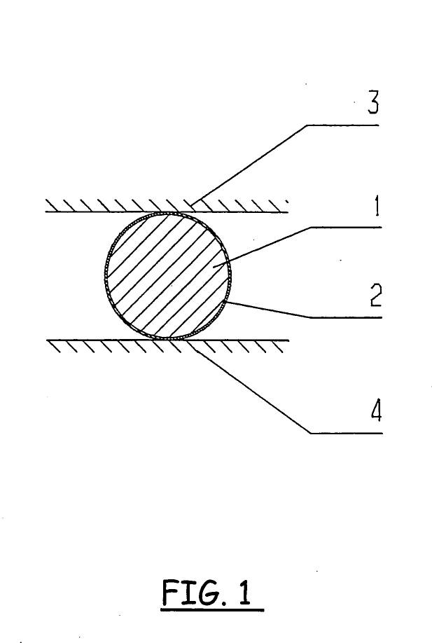

FIG. 1: an elastic contact element with a solid cross section,

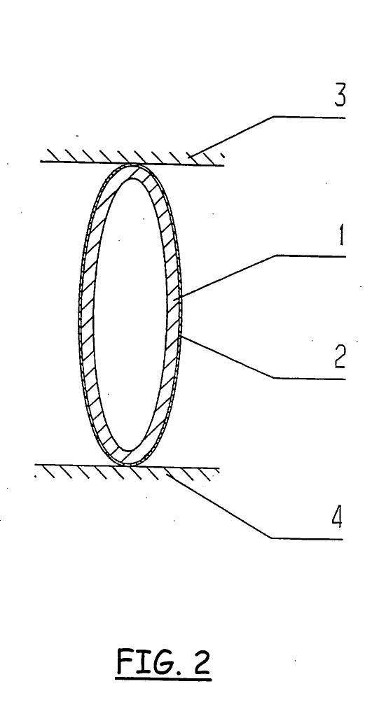

FIG. 2: an elastic contact element with a hollow cross section

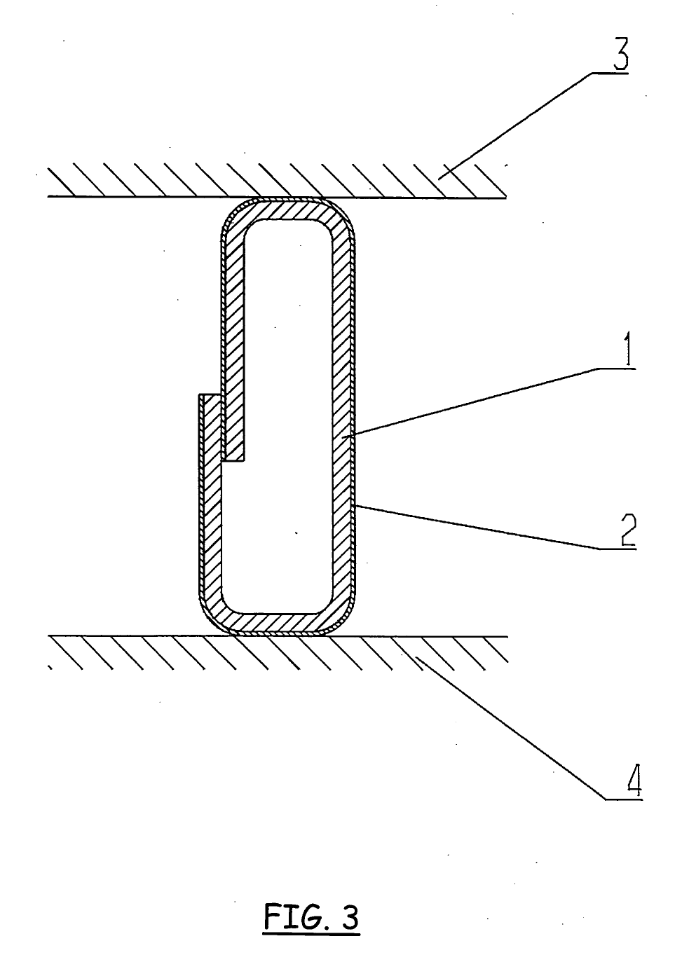

FIG. 3: an elastic element in strip shape

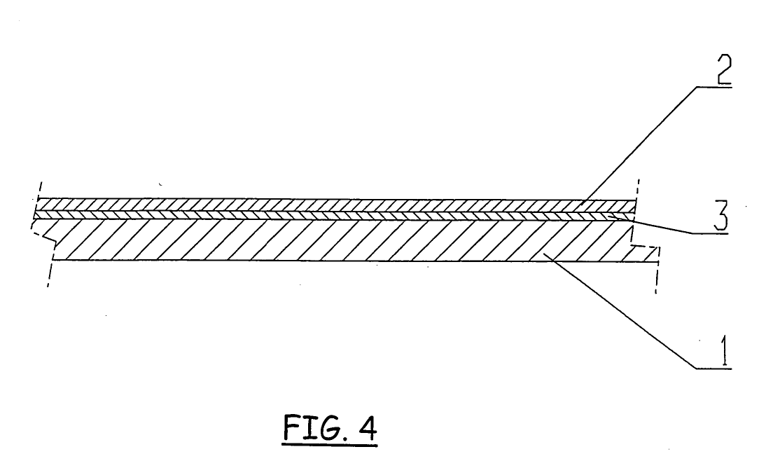

FIG. 4: an elastic element with at least one intermediate layer.

FIG. 1 shows as a contact device an electrical contact element with a solid profile or cross section which has a carrier 1 (for example in a ball shape, a circular shape or cylindrical shape), whereby the carrier 1 is composed of an electrically nonconductive material (like for example a silicone containing material). On the outer surface of the carrier 1, in an appropriate manner, for example, by dispersion, metal spraying, painting, printing (for example embossing) or by a chemogalvanic, electrostatic or like technique, an electrically conductive layer 2 is applied which at least partly envelopes the carrier 1 but especially also can envelope it completely. After the formation of such n elastically deformable contact element, it is disposed between two contact partners which in an especially advantageous manner can be configured as planar or at least partly convex or concave, contact surfaces 3, 4. By a relative movement of the two contact surfaces 3, 4 toward one another, the contact element is deformed (compressed) so that the one contact surface 3 comes into contact with the conducting layer 2 and is thereby electrically connected with the further contact surface 4. Through the movement of the two contact surfaces 3, 4 toward one another and by deformation of the carrier 1 and as a consequence of the electrically conductive layer, the elastic contact element maintains pressure against the contact surfaces 3 and 4 which causes the electrically conductive layer to bear reliably and permanently against the contact surfaces 3, 4. While in FIG. 1 a round, especially cylindrical profile of the elastic contact element has been shown, there are also other geometric shapes (ball shaped, triangular, square, rectangular, trapezoidal shapes with sharp or rounded edges or combinations of the aforementioned shapes as well as step shapes, bar shapes, constriction shapes or the like) which are conceivable.

FIG. 2 shows a contact device for making electrical contact in which the carrier 1 is configured as a hollow profile or cross section, that is that the carrier has an opening in its center and is not comprised of solid material. Otherwise the construction (that is the conductive layer 2 and the electrically nonconductive carrier 1) and the electrical contact made through the elastic contact element are the same as for the contact element described with reference to FIG. 1. Likewise the elastic contact element which has been illustrated in FIG. 2 can have a wide selection of geometric shapes and can be matched to the requirements as to where the contact element is to be located and the purposes for which it is to be used.

FIG. 3 shows as a contacting device an elastic contact element whose carrier has the shape of a strip which is provided at least on one side with the electrically conductive layer 2. The carrier can be used in the contacting device both with and without an overlapping and can be fastened in various ways. In this case the pressure force can be generated for example also with the aid of an elastic auxiliary element like a spring or the like.

FIG. 4 shows a contacting device which can have between the carrier 1 and the conductive layer 2 at least one adhesive layer which can be applied in an appropriate manner to the carrier. Then the conductive layer 2 can be applied by one of the ways described already above to the carrier 1.

An especially advantageous use of the device according to the invention is for contacting at least one contact surface on an antenna amplifier with at least one contact surface of an antenna structure on a planar or at least partially convex or concave surface of an automotive vehicle, whereby the elastic contact elements according to the invention combine the advantages of low fabrication costs for the contact element, the reliable, convenient and durable formation of the electrical connection, the ability to compensate for tolerances because of the elastic deformability and a simple replacement of the contacting device in the case of a defect in a simple manner and way since the elastic contact element according to the invention is releasably brought into contact with the associated contact element because of the elastic deformability. Furthermore such contact elements can be a part of the contacting elements corresponding to FIGS. 1-4 of the German patent application 103 16 384.0.

1. A device for making electrical contact between a first contact partner and at least one further contact partner comprising an elastically deformable carrier which is not electrically conductive and has at least partly an electrically conductive layer whereby the contact partners are electrically connected together by the layer.

2. The device according to claim 1 wherein the carrier is at least partly composed of a synthetic or compositionally modified high molecular weight material or a copolymer, derivative, or blend thereof.

3. The device according to claim 1 the carrier is comprised at least partially of a silicone containing material or a silicone or of a polyolefin copolymer, especially EPM or EPDM.

4. The device according to claim 1 wherein the carrier material is foamed.

5. The device according to claim 1 wherein the electrically conductive layer is applied by dispersion and/or metal spraying and/or painting and/or electrodeposition and/or by painting or embossing and/or chemogalvanically and/or electrostatically onto the carrier.

6. The device according to claim 1 wherein the electrically conductive layer is a foil which is applied to the carrier by means of adhesive.

7. The device according to claim 1 wherein at least one layer is provided between the conducting layer and the carrier which improves the adhesion of the conducting layer and is applicable to the carrier.

8. The device according to one claim 1 wherein the contact partners are contact surfaces.

9. The device according to claim 1 wherein the contact element has a solid or hollow cross section.

10. The device according to claim 1 wherein the contact element has a closed or opened profile.

11. The device according to claim 1 wherein the contact element is configured as a strip.

12. The device according to claim 1 wherein one or more contact elements are arranged in a contact device or contact adapter.

13. The device according to one claim 1 wherein the electrical contact is made between at least one contact surface of a signal processing device with at least one contact surface of an antenna structure disposed on a planar or at least partially convex or concave surface of an antenna structure.

14. An antenna assembly comprising:
an antenna structure upon a surface of an automotive vehicle;
a signal processing unit mounted on the automotive vehicle; and
a contact element under compression between said antenna structure and said signal processing unit, consisting of a body of an elastically compressible electrically conductive material having a surface covering of a layer of electrically nonconductive material making electrical contact between said antenna structure and said unit.

15. The antenna assembly defined in claim 14 wherein said body has a round solid cross section and said layer extends all around said body.

16. The antenna assembly defined in claim 14 wherein said body has an oval hollow cross section and said layer extends all around said body.

17. The antenna assembly defined in claim 14 wherein said body has the configuration of a strip, said layer covers a side of said strip and said strip is bent so that said side bears against said unit and said antenna structure.

18. The antenna assembly defined in claim 14 wherein said body is a silicone.
